(19) United States
(12) Patent Application Publication
(10) Pub. No.: US 2024/0148600 A1
(43) Pub. Date: May 9, 2024

(54) MASSAGE DEVICE

(71) Applicant: Aukey Technology Co., Ltd, Shenzhen (CN)

(72) Inventor: Xigen Xiao, Shenzhen (CN)

(21) Appl. No.: 18/414,483

(22) Filed: Jan. 17, 2024

Related U.S. Application Data
(63) Continuation-in-part of application No. 17/239,687, filed on Apr. 26, 2021, now Pat. No. 11,911,334.

(30) Foreign Application Priority Data
Jan. 27, 2021 (CN) 202120234243.7

(51) Int. Cl. A61H 7/00; A61H 15/02

(52) U.S. Cl. CPC A61H 7/007; A61H 15/02; A61H 2201/0228

(57) ABSTRACT

A massage device includes a base, a driving module, a massage head, and a heating module. The massage head is connected to the driving module, a side of the massage head away from the base is provided with a massage protrusion, and a first cavity is formed on a side of the massage head facing the base. The heating module is fixed relative to the base and located between the base and the massage head, wherein the heating module is configured to generate heat when energized to heat the air in the first cavity, so as to provide thermotherapy from the massage device to a part of a user's body.

### CROSS-REFERENCE TO RELATED APPLICATIONS

This application is a continuation-in-part of U.S. application Ser. No. 17/239,687, filed on Apr. 26, 2021, which is based upon and claims priority to Chinese Application No. 202120234243.7, filed on Jan. 27, 2021, and titled “MASSAGE DEVICE”, the entire contents of which are incorporated herein by reference.

### TECHNICAL FIELD

Embodiments of the present application relate to the technical field of massage equipment, and in particular, to a massage device.

### BACKGROUND

A massage device is a health product developed based on the principles of traditional meridian massage and modern medical massage. Currently, common massage devices on the market include massage pillows and massage cushions. Generally, a massage device includes a base, a massage head, and a driving module. The driving module is configured to drive the massage head to rotate so as to provide users with massage or percussion experience.

In addition, some massage devices further include a heating module, which is configured to heat the massage head, so as to increase user comfort and avoid poor user experience due to a low temperature of the massage head in a low temperature environment.

### SUMMARY

An embodiment of the present application provides a massage device, including:
a base;
a driving module, which is mounted on the base;
a massage head, which is connected to the driving module so as to be driven by the driving module to rotate relative to the base, wherein a side of the massage head away from the base is provided with a massage protrusion, and a first cavity is formed on a side of the massage head facing the base;
an enclosure, which is arranged on the base and located between the base and the massage head, wherein a free end of the enclosure away from the base extends into the first cavity, and an outer wall of the free end is arranged close to an inner wall of the massage head, there is a gap between the outer wall of the free end of the enclosure and the inner wall of the massage head, a second cavity in communication with the first cavity is formed in the enclosure, and the second cavity and the first cavity jointly form a heating chamber; and
a heating module, which is accommodated in the heating chamber and fixed relative to the base, and is configured to provide thermotherapy from the massage device.

Another embodiment of the present application provides a massage device, including:
a base, provided with an accommodating cavity;
a driving module, mounted on the base, wherein the driving module comprises a power assembly accommodated in the accommodating cavity and a driving shaft connected to the power assembly;
a massage head, connected to the driving shaft so as to be driven by the power assembly to rotate relative to the base, wherein a side of the massage head away from the base is provided with a massage protrusion, and a first cavity is formed on a side of the massage head facing the base;
a supporting part, fixed to the base and at least partially accommodated in the first cavity;
a heating module, fixed to the supporting part, and configured to generate heat when energized to heat the air in the first cavity, so as to provide thermotherapy from the massage device to a part of a user's body.

Another embodiment of the present application provides a massage device, including:
a base, provided with an accommodating cavity;
a driving module, mounted on the base, wherein the driving module comprises a power assembly accommodated in the accommodating cavity and a driving shaft connected to the power assembly;
a massage head, connected to the driving shaft so as to be driven by the power assembly to rotate relative to the base, wherein a side of the massage head away from the base is provided with a massage protrusion, and a first cavity is formed on a side of the massage head toward the base; and
a heating module, fixed relative to the base and located between the base and the massage head, wherein the heating module is configured to generate heat when energized to heat the air in the first cavity, so as to provide thermotherapy from the massage device to a part of a user's body.

### BRIEF DESCRIPTION OF DRAWINGS

One or more embodiments are illustrated using corresponding accompanying drawings, and the illustration does not constitute a limitation on the embodiments. Elements having a same reference numeral in the accompanying drawings indicate similar elements, and unless otherwise stated, a figure in the accompanying drawings does not constitute a scale limitation.

FIG. 1 is a schematic three-dimensional diagram of a massage device according to an embodiment of the present application;

FIG. 2 is a schematic cross-sectional view of the massage device in FIG. 1 in one direction;

FIG. 3 is a schematic exploded diagram of the massage device in FIG. 1 in one direction;

FIG. 4 is a schematic three-dimensional diagram of a massage head in FIG. 1 in one direction;

FIG. 5 is a schematic three-dimensional diagram of a massage head in FIG. 1 in another direction;

FIG. 6 is a schematic cross-sectional view of a massage device in one direction according to another embodiment of the present application;

FIG. 7 is a schematic exploded diagram of the massage device in FIG. 6 in one direction;

FIG. 8 is a schematic three-dimensional diagram of a massage device according to another embodiment of the present application;

FIG. 9 is a schematic exploded diagram of the massage device in FIG. 8 in one direction;

FIG. 10 is a schematic three-dimensional diagram of a massage head in FIG. 8 in one direction;

FIG. 11 is a schematic three-dimensional diagram of a massage head in FIG. 8 in another direction;

FIG. 12 is a schematic three-dimensional diagram of a massage head in FIG. 8 in another direction;

FIG. 13 is a schematic cross-sectional view of the massage head along the C-C line in FIG. 10;

FIG. 14 is a top view of the massage device in FIG. 8 with the massage head; and

FIG. 15 is a schematic three-dimensional diagram of a massage device covered with flexible materials according to another embodiment of the present application.

In the drawings:
1, 1B and 1C: massage device;
100, 100B and 100C: base; 110 and 110C: upper housing; 111C: protruding part; 120 and 120C: lower housing; 101: accommodating cavity;
200 and 200B: driving module; 210: driving shaft; 220: power assembly;
300, 300B and 300C: massage head; 310 and 310C: massage protrusion; 320 and 320C: connecting portion; 330 and 330C: mounting portion; 301, 301B and 301C: first cavity; 302 and 302C: heat-permeable hole;
400 and 400B: enclosure; 410 and 410B: bottom plate; 420 and 420B: side wall; 430 and 430C: supporting rib; 401 and 401B: second cavity; 440C: fitting seat; 450C: supporting part;
500, 500B and 500C: heating module; 510 and 510C: circuit board; 520 and 520C: heating element;
600C: foam; 601C: storage groove;
2: flexible materials.

### DETAILED DESCRIPTION

For ease of understanding of the present application, the following describes the present application in more detail with reference to accompanying drawings and specific embodiments. It should be noted that, when an element is expressed as being “fixed to”/“fixedly connected to”/“mounted to” another element, the element may be directly located on the another element, or there may be one or more intermediate elements in between; and when an element is expressed as being “connected to” another element, the element may be directly connected to the another element, or there may be one or more intermediate elements in between. The terms “vertical”, “horizontal”, “left”, “right”, “inner”, “outer”, and similar expressions used in this specification are merely intended for illustrative purposes.

Unless otherwise defined, all the technical and scientific terms used in this specification have the same meanings as those commonly understood by persons skilled in the art of the present application. The terms used in the specification of the present application are merely for the purpose of describing specific embodiments, and are not intended to limit the present application. The term “and/or” used in this specification includes any or all combinations of one or more associated listed items.

In addition, technical features included in different embodiments of the present application described below may be combined with each other provided that they do not conflict with each other.

In this specification, the “mounting” includes welding, screwing, clamping, bonding, etc. to fix or restrict a specific element or device to a specific position or place; the element or device may remain still in a specific position or place, or may move within a limited range; and the element or device can or cannot be detached after being fixed or restricted to the specific position or place, which is not limited in the embodiments of the present application.

In the related art, a heating module is mounted on an inner surface of the massage head and includes a brush with two contacts. Correspondingly, a ring-shaped conductive plate electrically connected to a control circuit board is mounted on the base, the ring-shaped conductive plate is provided with two coaxially arranged ring-shaped conductive copper rings, and the two contacts of the brush are respectively electrically connected to one of the conductive copper rings, so as to implement electrical connection between the heating module and the control circuit board mounted on the base.

In the process of implementing the present application, the inventor of the present application discovered that during the rotation of the brush with the massage head, the brush is likely to be in poor contact with the conductive copper rings. Consequently, the heating module cannot work continuously and stably.

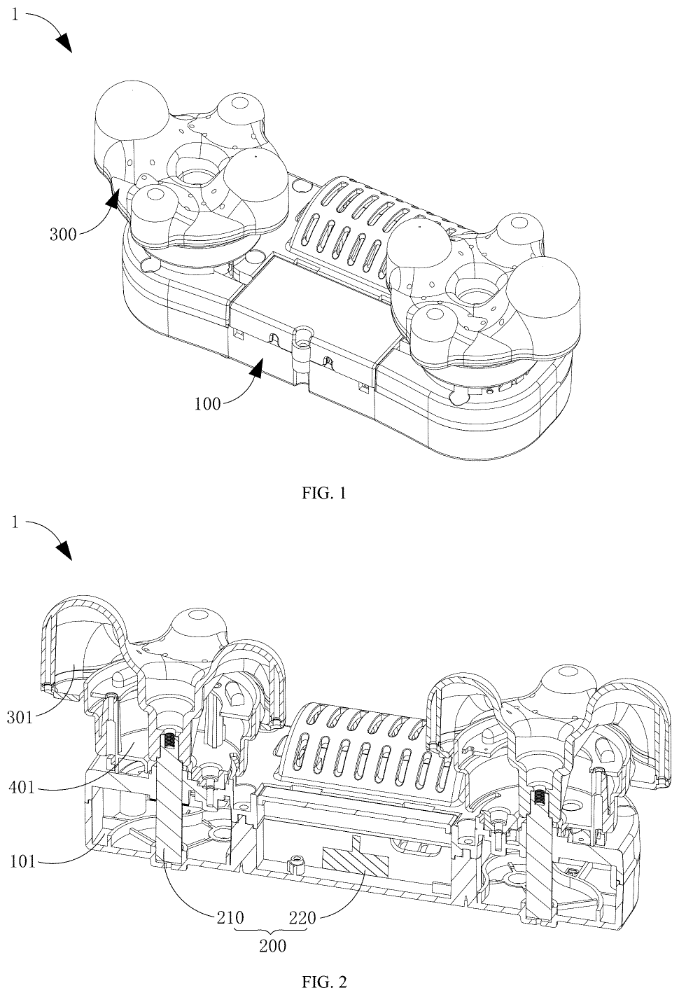

FIG. 1 to FIG. 3 respectively show a schematic three-dimensional diagram of a massage device 1, a schematic cross-sectional view of the massage device 1 in one direction, and a schematic exploded diagram of the massage device 1 in one direction according to an embodiment of the present application. The massage device 1 includes a base 100, a driving module 200, a massage head 300, an enclosure 400, and a heating module 500. The base 100 is a supporting and mounting structure for the foregoing structures. The driving module 200 is mounted on the base 100 and is a driving structure of the massage head 300 for driving the massage head 300 to rotate. The massage head 300 is connected to the driving module 200 so as to be driven by the driving module 200 to rotate relative to the base 100. A side of the massage head 300 away from the base 100 is provided with a massage protrusion 310, and a first cavity 301 is formed on a side of the massage head 300 facing the base. The enclosure 400 is arranged on the base 100 and is located between the base 100 and the massage head 300. A free end of the enclosure 400 away from the base 100 extends into the first cavity 301, and an outer wall of the free end is arranged close to an inner wall of the massage head 300. A second cavity 401 in communication with the first cavity 301 is formed in the enclosure 400, and the second cavity 401 and the first cavity 301 jointly form a heating chamber. The heating module 500 is accommodated in the heating chamber and fixed relative to the base 100, and is configured to provide thermotherapy from the massage device 1 to a user's body parts such as neck and waist. To better understand a specific structure of the massage device 1, the following describes specific structures of the base 100, the massage head 300, the enclosure 400, the heating module 500, and the driving module 200 in sequence.

For the base 100, references are made to FIG. 1 to FIG. 3. The base 100 has a box-like structure as a whole, and is provided with an accommodating cavity 101 for accommodating at least a part of the driving module 200. Specifically, the base 100 includes an upper housing 110 and a lower housing 120, and the upper housing 110 and the lower housing 120 jointly form the accommodating cavity 101.

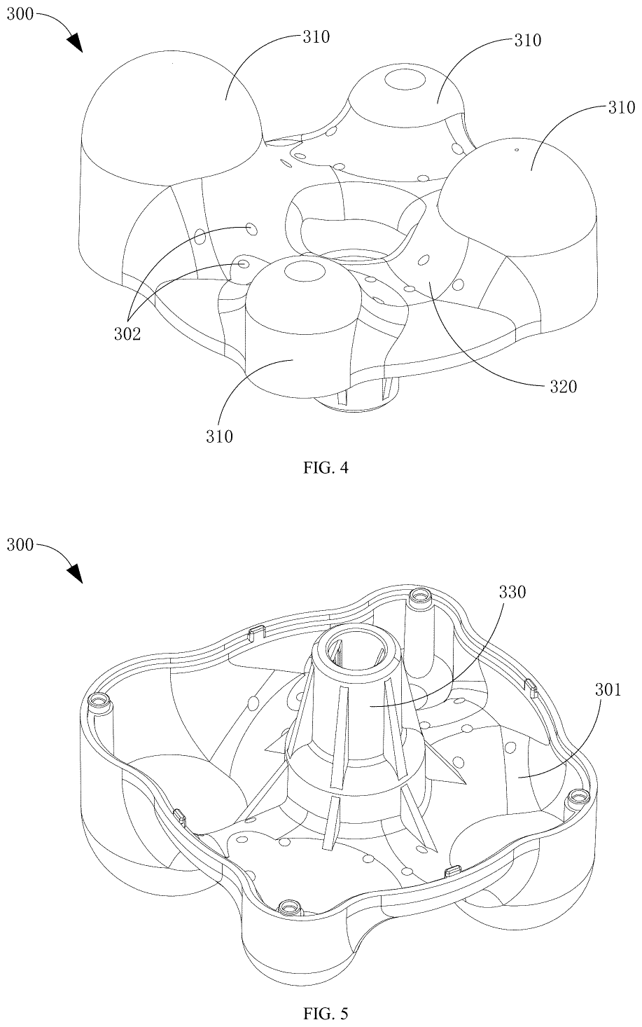

For the massage head 300, references are made to FIG. 4 and FIG. 5, which respectively show schematic three-dimensional diagrams of the massage head 300 in two directions. The massage head 300 is a structure that applies force to a user through rotation, so that the user experiences a massage effect. An end of the massage head 300 away from the base 100 is provided with a massage protrusion 310 for applying force to the user during the rotation of the massage head 300; and an end of the massage head 300 facing the base 100 defines a first cavity 301. In this embodiment, the massage head 300 includes a plurality of massage protrusions 310, and the massage protrusions 310 are connected and fixed through a connecting portion 320. Optionally, the massage head 300 includes four massage protrusions 310, and the massage protrusions 310 are respectively arranged at four corners of the connecting portion 320. Preferably, to ensure that the force applied by the massage head 300 to the user during the massage for the user can be changed intermittently, so that the user can feel a change in the pressing force, so as to better simulate the feeling of real massage and further improve the user's pressing experience, at least one of the massage protrusions 310 in the massage head 300 is different from the rest of the massage protrusions 310; and the “difference” may be a difference in shape or a difference in volume. Optionally, the massage device 1 includes two massage heads 300, and the two massage heads 300 are arranged on the same side of the base 100 at intervals.

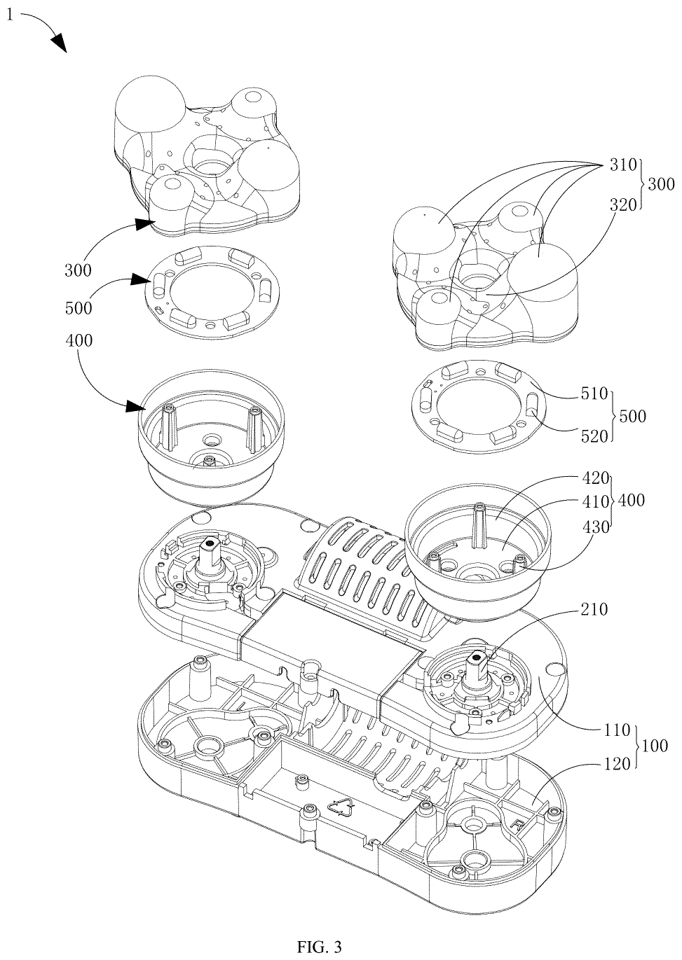

For the enclosure 400, references are made to FIG. 3. The enclosure 400 is arranged between the base 100 and the massage head 300, and includes a bottom plate 410 and a side wall 420. The bottom plate 410 is fixed on an outer surface of the base 100. The side wall 420 extends from an edge of the bottom plate 410 toward the massage head 300, a free end of the side wall 420 extends into the first cavity 301, and the side wall 420 and the bottom plate 410 jointly form a second cavity 401. The second cavity 401 is in communication with the first cavity 301, which forms a heating chamber together with the first cavity 301. The heating module 500 is accommodated in the heating chamber to reduce a waste caused by direct escape of heat generated by the heating module 500 into the air from a gap between the massage head 300 and the base 100. Preferably, an outer wall of the free end of the enclosure 400 extending into the first cavity 301 is arranged close to an inner wall of the massage head 300, so as to reduce a rate of escape of heat generated by the heating module 500 from the heating chamber through a gap between the enclosure 400 and the massage head 300, and at the same time, to prevent the massage head 300 from rubbing against the enclosure 400 during the rotation. A fitting gap between the outer wall of the free end of the enclosure 400 and the inner wall of the massage head 300 is relatively small, and is usually controlled within 10 millimeters (mm). For example, the fitting gap is less than 5 mm. For another example, the fitting gap is 3 mm. In this embodiment, the enclosure 400 and the base 100 are formed separately, and are fixedly connected through screwing, clamping, etc. It can be understood that in other embodiments of the present application, the enclosure 400 may alternatively be integrally formed with the base 100.

For the heating module 500, references are made to FIG. 3 and other drawings. The heating module 500, the massage head 300, and the enclosure 400 are in one-to-one correspondence. The heating module 500 is specifically accommodated in the second cavity 401, and includes a circuit board 510 and a heating element 520. The heating element 520 is mounted on the circuit board 510, and is electrically connected to the circuit board 510. Specifically, the enclosure 400 further includes a plurality of supporting ribs 430. The supporting ribs 430 are accommodated in the second cavity 401. One end of the supporting rib is fixed to the bottom plate 410 and the other end of the supporting rib extends toward the massage head 300. The supporting ribs 430 are distributed in a circular array around a rotation axis of the massage head 300. The circuit board 510 is in a ring shape arranged around a driving shaft 210, and is carried on the supporting ribs 430 and fixed to the supporting ribs 430. The heating element 520 is fixed to a side of the circuit board 510 away from the bottom plate 410, and is configured to generate heat when energized, so as to heat the massage head 300. When the massage device 1 is working, because the heating element 520 is fixed relative to the base 100 and the massage head 300 rotates above the heating element 520, the heating element 520 can heat various parts of the massage head 300 to ensure that temperatures of various areas of the massage head 300 are basically the same. Optionally, the heating element 520 includes a miniature tungsten lamp, which is an element that can emit light and generate heat when energized, and can be purchased directly on the market. It can be understood that in other embodiments of the present application, the heating element may alternatively be another element such as a heating wire, provided that it can generate heat when energized. Preferably, to further make a heating effect of the heating module 500 on the massage head 300 more uniform, the heating module 500 specifically includes a plurality of heating elements 520, and the heating elements 520 are distributed in a circular array around the rotation axis of the massage head 300.

Further, when a user is being massaged, to enable a part of the heat generated by the heating module 500 to rush to the user's body part through the massage head 300 to achieve a better thermotherapy effect, the massage head 300 is provided with a number of heat-permeable holes 302. The heat-permeable hole 302 is arranged through the massage head 300 to communicate the first cavity 301 with an external environment of the massage head 300. As such, when the heating module 500 generates heat, the heat escapes to the outside of the massage device 1 through the heat-permeable hole 302 and flows to the user, thereby enhancing the thermotherapy effect. In some embodiments, there are no penetrating heat-permeable holes 302 at the top of any massage protrusion 310, such as those heat-permeable holes 302 are arranged on the connecting portion 320 of the massage head 300, to reduce the wear caused by the heat-permeable holes 302 to flexible materials wrapped around the massage device 1.

Finally, the driving module 200 is described. Referring to FIG. 2 and other drawings, the driving module 200 includes a driving shaft 210 and a power assembly 220. The driving shaft 210 is connected to the massage head 300 in one-to-one correspondence. The power assembly 220 is connected to each driving shaft 210, and the power assembly 220 is configured to drive the driving shaft 210 to rotate, so that the massage head 300 is driven by the driving shaft 210 to rotate relative to the base 100.

Specifically, the driving shaft 210 is rotatably mounted on the base 100; a part of the driving shaft 210 is accommodated in the accommodating cavity 101; and a part of the driving shaft 210 extends out of the base 100, then passes through the bottom plate 410 of the enclosure 400, and extends into the second cavity 401. The massage head 300 is fixed to the part of the driving shaft 210 extending into the second cavity 401, so as to be rotatably mounted on the base 100. In this embodiment, a middle position of the massage head 300 extends toward the base 100 to form a mounting portion 330; and the mounting portion 330 has a cylindrical shape, at least partially extends into the second cavity 401, and is connected to the driving shaft 210. Optionally, the mounting portion 330 is detachably connected to the driving shaft 210 through threading, interference fitting, etc.

The power assembly 220 is separately connected to the two driving shafts 210 described above. In this embodiment, the power assembly 220 includes a driving motor (not shown in the figure) and two transmission modules (not shown in the figure). The driving motor is separately connected to the two transmission modules, and a transmission module is correspondingly connected to a driving shaft 210, so that the massage device 1 can drive, through the driving motor, the driving shaft 210 to rotate, and then drive the corresponding massage head 300 to rotate. Optionally, rotation directions of the two driving shafts 210 are opposite, so that the two massage heads 300 can squeeze a user's muscles toward each other during operation, so as to achieve a better massage effect. Optionally, the transmission module includes a gear group. It can be understood that in other embodiments, the transmission module may alternatively be another mechanism capable of implementing rotational output. For example, in some other embodiments of the present application, the transmission module may further include a synchronous belt mechanism, or may include both a gear group and a synchronous belt mechanism.

It should be further understood that in other embodiments of the present application, the driving module 200 may alternatively have another structural form, provided that it is connected to the massage head 300 and can drive the massage head 300 to rotate. For example, in some embodiments, the driving module 200 includes only two driving motors, and one driving motor is correspondingly connected to one massage head 300. For another example, in some other embodiments, the driving module 200 includes a driving motor and a transmission module, the driving motor is directly connected to one massage head 300 and the transmission module, and the other massage head 300 is connected to the transmission module. Specific structures of the driving module 200 are not listed one by one in the present application.

In addition to the foregoing structures, the massage device 1 further includes a control circuit board (not shown in the figure) for controlling the heating of the heating module 500 and controlling the operation of the driving module 200. Specifically, the control circuit board is a main control module of the massage device 1, and is accommodated in the accommodating cavity 101; and the heating module 500 and the driving module 200 are both connected to the control circuit board.

The massage device 1 provided in the embodiments of the present application includes a base 100, a driving module 200, a massage head 300, an enclosure 400, and a heating module 500. A side of the massage head 300 away from the base 100 is provided with a massage protrusion 310, and a first cavity 301 is formed on a side of the massage head 300 facing the base 100. The driving module 200 is connected to the massage head 300 and configured to drive the massage head 300 to rotate. The enclosure 400 is arranged between the base 100 and the massage head 300, a free end of the enclosure 400 away from the base 100 extends into the first cavity 301, the enclosure 400 defines a second cavity 401 in communication with the first cavity 301, and the second cavity 401 and the first cavity 301 form a heating chamber. The heating module 500 is accommodated in the heating chamber and fixed relative to the base 100, and is configured to provide thermotherapy from the massage device 1 to a part of a human body.

In comparison with an existing massage device on the market, according to the massage device 1 provided in the embodiments of the present application, the heating module 500 is arranged to be fixed relative to the base 100, so that the heating module 500 in the massage device 1 is connected to the control circuit board without using a brush and a ring-shaped conductive plate. Therefore, the massage device 1 provided in the embodiments of the present application can solve the problem that a heating module of the existing massage device on the market cannot work continuously and stably due to poor contact between a brush and a conductive copper ring.

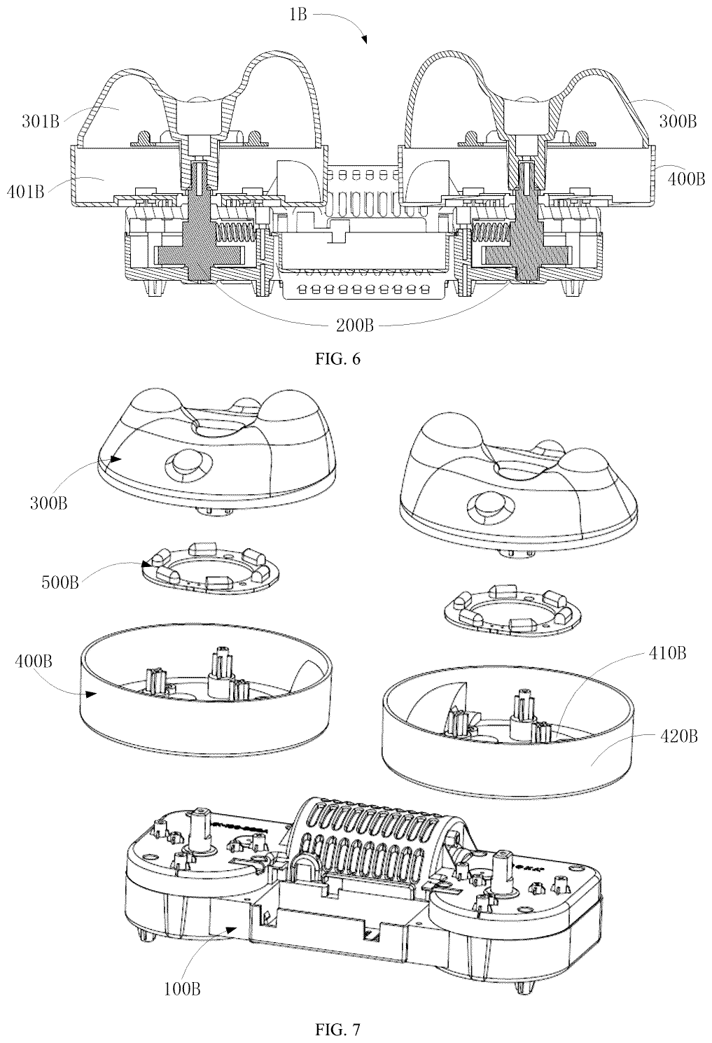

Based on the same inventive concept, the present application further provides another massage device. FIG. 6 and FIG. 7 show a schematic cross-sectional view and a schematic exploded diagram of a massage device 1B in one direction according to another embodiment of the present application. Same as the massage device 1 in the first embodiment, the massage device 1B includes a base 100B, a driving module 200B, a massage head 300B, an enclosure 400B, and a heating module 500B. References are made to FIG. 2, and main differences between the massage device 1B and the massage device 1 in the first embodiment are as follows:

The free end of the enclosure 400 of the massage device 1 away from the base 100 extends into the first cavity 301, and the outer wall of the free end is arranged close to the inner wall of the massage head 300. However, in the second embodiment, an open end of the massage head 300B close to the base 100B extends into the enclosure 400B, an outer wall of the open end is arranged close to an inner wall of the enclosure 400B, and an outer diameter of the open end of the massage head 300B is slightly smaller than an inner diameter of the inner wall of the enclosure 400B. A difference between the outer diameter of the open end of the massage head 300B and the inner diameter of the inner wall of the enclosure 400B can be controlled within 10 millimeters (mm). For example, the difference is less than 5 mm. For another example, the difference is 3 mm.

Specifically, the end of the massage head 300B close to the base 100B is an open end, and the open end is in communication with a first cavity 301B; the enclosure 400B includes a bottom plate 410B and a side wall 420B; the bottom plate 410B is fixed on an outer surface of the base 100B; the side wall 420B extends from an edge of the bottom plate 410B toward the massage head 300B; and the side wall 420B and the bottom plate 410B jointly form a second cavity 401B. The open end of the massage head 300B extends into the end of the enclosure 400B away from the base 100B, and the outer wall of the open end is arranged close to the inner wall of the side wall 420B. The second cavity 401B is in communication with the first cavity 301B through the open end of the massage head 300B, and the second cavity 401B and the first cavity 301B jointly form a heating chamber.

The heating module 500B is accommodated in the second cavity 401B, and can heat the massage head 300B when the massage device 1B is working. Because the heating module 500B is fixed relative to the base 100B, and the massage head 300B rotates above the heating element 520, the continuous and stable operation of the heating module 500B can be ensured.

In other embodiments, the open end of the massage head 300B may not extend into the enclosure 400B, but is arranged above the enclosure 400B. In this case, there is an up-and-down gap between the open end of the massage head 300B and the end of the enclosure 400B away from the base 100B. Likewise, the gap is controlled within 10 millimeters (mm) to reduce a rate of escape of heat generated by the heating module 500B from the heating chamber through a gap between the enclosure 400B and the massage head 300B, and at the same time, to prevent the massage head 300B from rubbing against the enclosure 400B during the rotation.

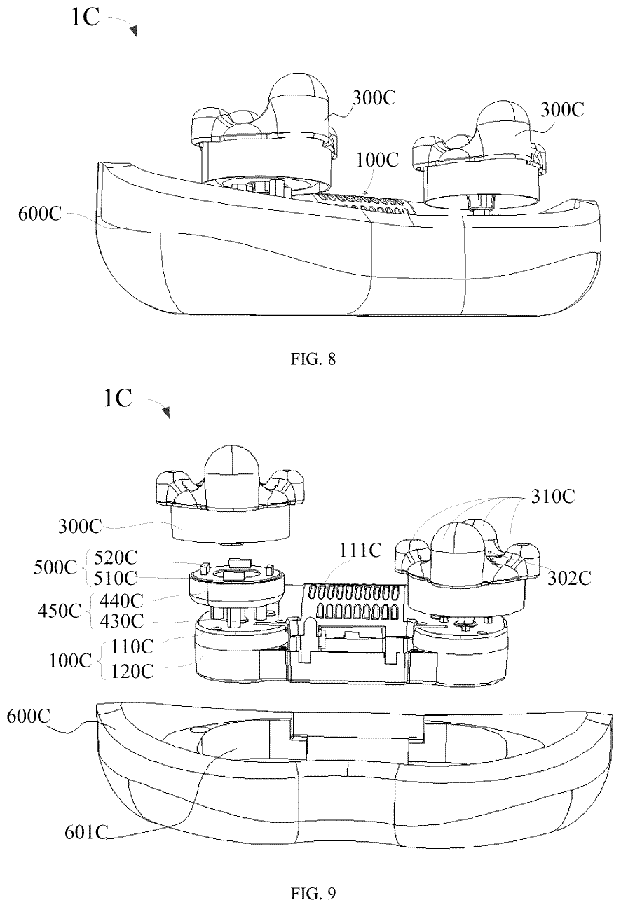

Based on the same inventive concept, the present application further provides another massage device. FIG. 8 and FIG. 9 show a schematic three-dimensional diagram and a schematic exploded diagram of a massage device 1C in one direction according to another embodiment of the present application. The massage device 1C includes a base 100C, a driving module (not shown in the figure), a massage head 300C, a heating module 500C and a foam 600C. Wherein, the base 100C, the driving module, and the heating module 500C in the massage device 1C can refer to the base 100, the driving module 200 and the heating module 500 in the massage device 1 respectively, or the base 100B, driving module 200B and the heating module 500B in the massage device 1B respectively.

References are made to FIG. 2 or FIG. 6, the differences between the massage device 1C and the massage device 1 in the first embodiment or the massage device 1B in the second embodiment are as follows:

The heating module (500, 500B) in the massage device 1 or the massage device 1B is relatively fixed to the base (100, 100B) through the enclosure (400, 400B). The enclosure (400, 400B) in the massage device 1 or the massage device 1B is not a necessary structure. However, in the third embodiment, the massage device 1C does not include an enclosure, the heating module 500C is relatively fixed to the base 100C without an enclosure.

In some embodiments, the heating module 500C is directly fixed to the base 100C and located between the base 100C and the massage head 300C. The end of the massage head 300C toward the base 100C is an open end and defines a first cavity 301C. There is an up-and-down gap between the open end of the massage head 300C and the base 100C. Likewise, the gap is controlled within 10 millimeters (mm) to reduce a rate of escape of heat generated by the heating module 500C from the first cavity 301C through the gap between the base 100C and the massage head 300C, and at the same time, to prevent the massage head 300C from rubbing against the base 100C during the rotation.

The heating module 500C fixed to the base 100C is located near or extends into the open end of the massage head 300C, and is partially or completely accommodated in the first cavity 301C, without contacting with the inner wall of the open end of the massage head 300C. Therefore, the heating module 500C is relatively fixed to the base 100C, and the massage head 300C rotates above the heating module 500C, which can heat the air in the first cavity 301C.

In some another embodiments, the massage device 1C further includes a supporting part 450C. The supporting part 450C is fixed to the base and located between the base 100C and the massage head 300C. The supporting part 450C is at least partially accommodated in the first cavity 301C. The heating module 500C is mounted on the supporting part 450C.

In accordance with some embodiments, the supporting part 450C includes a plurality of supporting ribs 430C, wherein one end of a supporting rib 430C is fixed to the base 100C, the other end of the supporting rib 430C extends toward the massage head 300C, extending into the first cavity 301C. The supporting ribs 430 are distributed in a circular array around a rotation axis of the massage head 300C. In some embodiments, the supporting ribs 430C are integrally formed with the base 100C. The heating module 500C is carried on the supporting ribs 430C and is fixed to the supporting ribs 430C.

In these embodiments, the heating module 500C is lifted by the support ribs 430C, close to heat-permeable holes 302C at the massage head 300C, which is conducive to heat conduction to the user.

In accordance with some embodiments, referring to FIG. 9, the supporting part 450C further includes a fitting seat 440C. The fitting seat 440C is in a ring shape arranged around a driving shaft, and is carried on the supporting ribs 430C. The heating module 500C is fixed to the side of the fitting seat 440C away from the base 100C. For example, the circuit board 510C of the heating module 500C is screwed onto the fitting seat 440C, and the heating element 520C of the heating module 500C is mounted on the side of the circuit board 510C away from the fitting seat 440C, that is, the heating element 520C faces massage protrusions 310C and the heat-permeable holes 302C in the massage head 300C. In this way, the heating module 500C is easy to install.

In other embodiments, the supporting part 450C can also be in other forms, optionally, the supporting part 450C only includes an fitting seat 440C fixed on the surface of the base 100C, and the heating module 500C is mounted on the fitting seat 440C. Optionally, the supporting part 450C includes multiple supporting ribs 430C and a fitting seat 440C, wherein the fitting seat is fixed on the surface of the base 100C, with one end of the multiple support ribs 430C fixed to the fitting seat 440C and the other end carrying the heating module 500C.

The differences between the massage device 1C and the massage device 1 in the first embodiment or the massage device 1B in the second embodiment are also as follows:

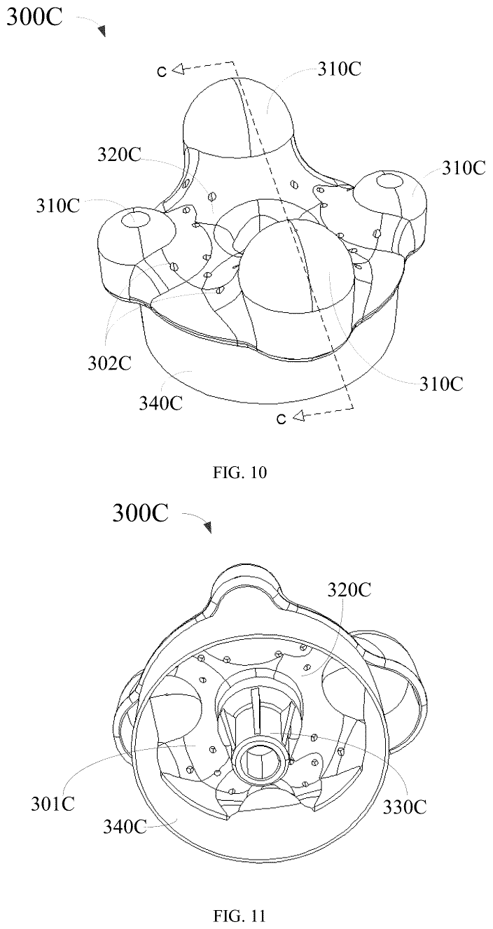

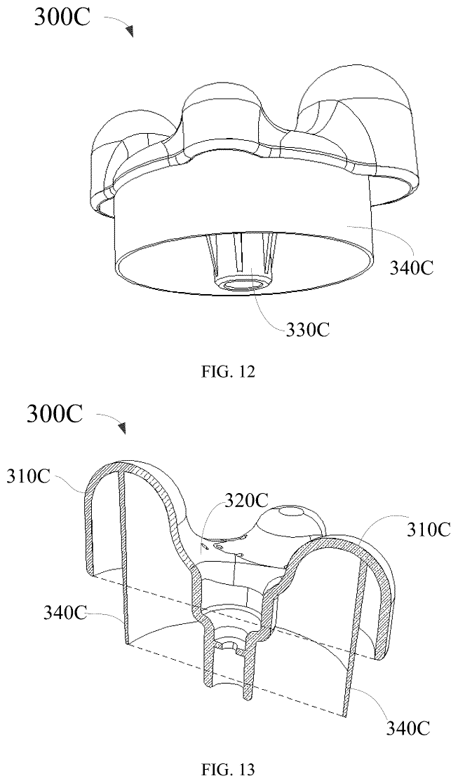

References are made to FIG. 10 to FIG. 13 together, FIG. 10, FIG. 11 and FIG. 12 respectively show schematic three-dimensional diagrams of the massage head 300C in three directions, FIG. 13 shows a schematic cross-sectional view of the massage head 300C along the C-C line. An end of the massage head 300C away from the base 100C is provided with a plurality of massage protrusions 310C, and another end of the massage head 300C toward the base 100C is formed by a extending part 340C and a mounting portion 330C. The massage protrusions 310C and the mounting portion 330C can refer to the massage protrusion 310 and the mounting portion 330 in the massage device 1, respectively. An end of the extending part 340C extends to the top of each massage protrusion 310C, dividing each massage protrusion 310C into two independent spaces, thereby improving the strength and stiffness of each massage protrusion 310C. Another end of the extending part 340C toward the base 100C is beyond the lower edge of each massage protrusion 310C. The extending part 340C, a portion of each massage protrusion 310C and a connecting part 320C connected and fixed each massage protrusion 310C jointly form the first cavity 301C. The heating module 500C is accommodated in the first cavity 301C, thereby effectively reducing heat loss.

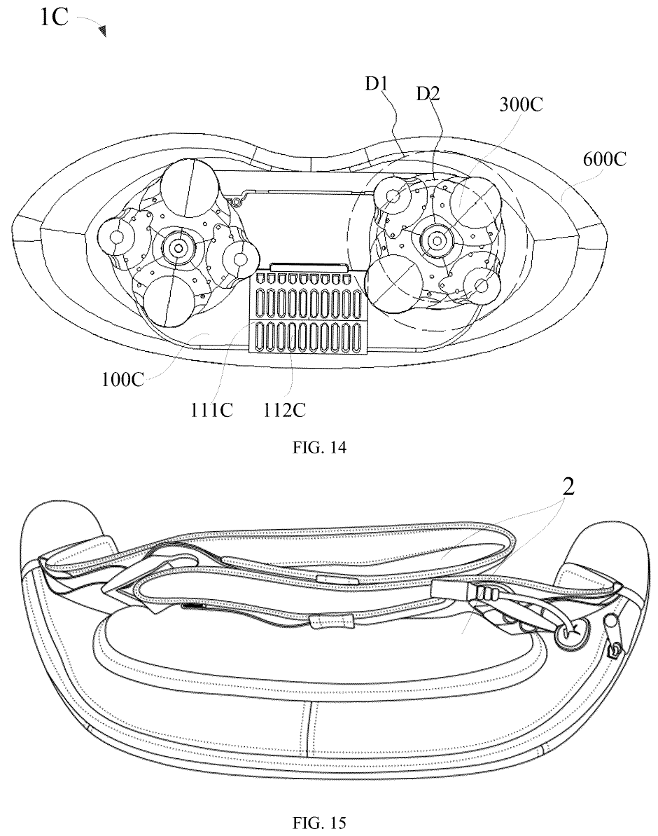

Please refer to FIG. 14, which is a top view of the massage device 1C with the massage head 300C. When the massage head 300C is in a rotating state, the maximum circle D1 projected by the massage head 300C on the base 100C and a circle D2 projected by the extending part 340C on the base 100C are concentric circles. The diameter of the circle D2 projected by the extending part 340C on the base 100C is smaller than the diameter of the maximum circle D1 projected by the massage head 300C in a rotating state on the base 100C. That is to say, the diameter of the massage head 300C near the base 100C is reduced, which can avoid other protruding components on the base 100C, making the structure of the massage device 1C more compact.

In some embodiments, the other protruding components include driving motor. The driving motor drives the driving shaft, which in turn drives the corresponding massage head 300C to rotate. Please refer to FIG. 9 and FIG. 14, the base 100C includes an upper housing 110C and a lower housing 120C, and the upper housing 110C and the lower housing 120C jointly form an accommodating cavity. The driving motor is accommodated in the accommodating cavity. To adapt to the shape of the driving motor, the upper housing 110C is equipped with a protruding part 111C, allowing the driving motor to be at least partially accommodated in a cavity within the protruding part 111C. In addition, there are some heat emission holes 112C on the protruding part 111C to providing emission route for the driving motor. Refer to FIG. 14, if the outermost edge of each massage protrusion 310C extends downwards as a whole, the maximum circle D1 projected by the massage head 300C in a rotating state on the base 100C overlaps with the protruding part 111C, indicating that the massage head 300C will collide with the protruding part 111C when rotating.

In these embodiment, the circle D2 projected by the extending part 340C on the base 100C is smaller than the maximum circle D1 projected by the massage head 300C in a rotating state on the base 100C, so that the massage head 300C effectively avoids the protruding part 111C, making the structure of the massage device 1C more compact. In other words, the extending part 340C is staggered from the protruding part 111C in the direction perpendicular to the driving shaft, the massage head 300C in a rotating state is staggered from the protruding part 111C in the direction parallel to the driving shaft. As a result, collision can be avoided and the structure of the massage device 1C can be more compact.

In some embodiments, please refer to FIG. 15, either massage device 1, massage device 1B, or massage device 1C is wrapped in flexible materials 2. The massage device (1, 1B or 1C) is constructed as wearable heating massager for the user's body parts such as neck, shoulder, waist and legs, in conjunction with a control module and a charging module. Wherein, the flexible materials 2 include but is not limited to fabrics, leather, etc. The control module includes but not limit to control buttons integrated into the massage device (1, 1B or 1C), wireless modules that work in conjunction with a remote control and wireless control modules that work in conjunction with apps in handheld smart device. The charging module includes but not limit to battery units integrated into the massage device, wired plugs manually plugged into external sockets, etc.

Please refer to FIG. 9 again, the massage device 1C includes a foam 600C with a boat shaped structure as a whole. The top of the foam 600C is formed with a storage groove 601C that is adapted to the base 100C in volume and shape. The base 100C is fixed or detachably fixed in the storage groove 601C at the top of the foam 600C. It should be noted that the foam 600C can also be applied to the base 100 in the massage device 1 and the base 100B in the massage device 1B. In other optional embodiments, general skilled personnel in this field can adjust and design the overall structure of the foam 600C according to the actual application scenario of the massage device 1C or the body parts or ergonomics mainly targeted at the user.

Finally, it should be noted that the foregoing embodiments are merely intended for describing the technical solutions of the present application, but not for limiting the present application. Under the idea of the present application, the technical features in the foregoing embodiments or in different embodiments can be combined, the steps can be implemented in any order, and there are many other changes in different aspects of the present application described above. For brevity, they are not provided in detail. Although the present application is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of the embodiments of the present application.

What is claimed is:

1. A massage device, comprising:
a base;
a driving module, which is mounted on the base;
a massage head, which is connected to the driving module so as to be driven by the driving module to rotate relative to the base, wherein a side of the massage head away from the base is provided with a massage protrusion, and a first cavity is formed on a side of the massage head facing the base;
an enclosure, which is arranged on the base and located between the base and the massage head, wherein a free end of the enclosure away from the base extends into the first cavity, and an outer wall of the free end is arranged close to an inner wall of the massage head, there is a gap between the outer wall of the free end of the enclosure and the inner wall of the massage head, a second cavity in communication with the first cavity is formed in the enclosure, and the second cavity and the first cavity jointly form a heating chamber; and
a heating module, which is accommodated in the heating chamber and fixed relative to the base, and is configured to provide thermotherapy from the massage device.

2. The massage device according to claim 1, wherein the enclosure comprises a bottom plate and a side wall, and the bottom plate and the side wall jointly form the second cavity; and
the bottom plate is fixed on the base, the side wall extends from the bottom plate toward the massage head, and a free end of the side wall extends into the first cavity.

3. The massage device according to claim 1, wherein the gap between the outer wall of the free end of the enclosure and the inner wall of the massage head is within 10 millimeters.

4. The massage device according to claim 1, wherein the massage head is provided with a plurality of massage protrusions, and there are a number of penetrating heat-permeable holes arranged through the massage head to communicate the first cavity with an external environment of the massage head; there are no penetrating heat-permeable holes at the top of any massage protrusion.

5. The massage device according to claim 1, wherein the massage device further comprises a foam with a boat shaped structure, the top of the foam is formed with a storage groove adapted to the base, and the base is installed in the storage groove.

6. The massage device according to claim 1, wherein the massage device further comprises flexible materials which wrap around the massage device.

7. A massage device, comprising:
a base, provided with an accommodating cavity;
a driving module, mounted on the base, wherein the driving module comprises a power assembly accommodated in the accommodating cavity and a driving shaft connected to the power assembly;
a massage head, connected to the driving shaft so as to be driven by the power assembly to rotate relative to the base, wherein a side of the massage head away from the base is provided with a massage protrusion, and a first cavity is formed on a side of the massage head facing the base;
a supporting part, fixed to the base and at least partially accommodated in the first cavity;
a heating module, fixed to the supporting part, and configured to generate heat when energized to heat the air in the first cavity, so as to provide thermotherapy from the massage device to a part of a user's body.

8. The massage device according to claim 7, wherein the supporting part comprises a plurality of supporting ribs and a fitting seat;
one end of a supporting rib is fixed to the base, the other end of the supporting rib extends toward the massage head, the fitting seat is carried by and fixed to the supporting ribs; and
the heating module is fixed to the fitting seat.

9. The massage device according to claim 7, wherein the massage head is provided with a plurality of massage protrusions, and there are a number of penetrating heat-permeable holes arranged through the massage head to communicate the first cavity with an external environment of the massage head; there are no penetrating heat-permeable holes at the top of any massage protrusion.

10. The massage device according to claim 7, wherein an extending part is formed on the side of the massage head toward the base, the extending part extends to the top of the massage protrusion, dividing the massage protrusion into two independent spaces.

11. The massage device according to claim 7, wherein an extending part is formed on the side of the massage head toward the base, the diameter of the circle projected by the extending part on the base is smaller than the diameter of the maximum circle projected by the massage head in a rotating state on the base.

12. The massage device according to claim 7, wherein the massage device further comprises a foam with a boat shaped structure, the top of the foam is formed with a storage groove adapted to the base, and the base is installed in the storage groove.

13. The massage device according to claim 7, wherein the massage device further comprises flexible materials which wrap around the massage device.

14. A massage device, comprising:
a base, provided with an accommodating cavity;
a driving module, mounted on the base, wherein the driving module comprises a power assembly accommodated in the accommodating cavity and a driving shaft connected to the power assembly;
a massage head, connected to the driving shaft so as to be driven by the power assembly to rotate relative to the base, wherein a side of the massage head away from the base is provided with a massage protrusion, and a first cavity is formed on a side of the massage head toward the base; and
a heating module, fixed relative to the base and located between the base and the massage head, wherein the heating module is configured to generate heat when energized to heat the air in the first cavity, so as to provide thermotherapy from the massage device to a part of a user's body.

15. The massage device according to claim 14, wherein the massage head is provided with a plurality of massage protrusions, and there are a number of penetrating heat-permeable holes arranged through the massage head to communicate the first cavity with an external environment of the massage head; there are no penetrating heat-permeable holes at the top of any massage protrusion.

16. The massage device according to claim 14, wherein the massage device further comprises an enclosure arranged on the base, a second cavity in communication with the first cavity is formed in the enclosure, and the second cavity and the first cavity jointly form a heating chamber;
the heating module is mounted in the enclosure and configured to generate heat when energized to heat the air in the heating chamber.

17. The massage device according to claim 14, wherein the massage device comprises a supporting part fixed to the base and at least partially accommodated in the first cavity;
the heating module is mounted on the supporting part.

18. The massage device according to claim 17, wherein the supporting part comprises a plurality of supporting ribs and a fitting seat;
one end of a supporting rib is fixed to the base, the other end of the supporting rib extends toward the massage head, the fitting seat is carried by and fixed to the supporting ribs; and
the heating module is fixed to the fitting seat.

19. The massage device according to claim 14, wherein an extending part is formed on the side of the massage head toward the base, the extending part extends to the top of the massage protrusion, dividing the massage protrusion into two independent spaces.

20. The massage device according to claim 14, wherein an extending part is formed on the side of the massage head toward the base, the extending part is staggered from a protruding part formed on the surface of the base in the direction perpendicular to the driving shaft;
the massage head in a rotating state is staggered from the protruding part in the direction parallel to the driving shaft.
